(19) United States
(12) Patent Application Publication
(10) Pub. No.: US 2015/0268800 A1
(43) Pub. Date: Sep. 24, 2015

(54) Method and System for Dynamic Playlist Generation

(71) Applicants: Timothy Chester O'Konski, Palo Alto, CA (US); Masahiko Nishimura, Campbell, CA (US)

(72) Inventors: Timothy Chester O'Konski, Palo Alto, CA (US); Masahiko Nishimura, Campbell, CA (US)

(21) Appl. No.: 14/514,363

(22) Filed: Oct. 14, 2014

Related U.S. Application Data
(63) Continuation-in-part of application No. 14/218,958, filed on Mar. 18, 2014, now abandoned.

(51) Int. Cl. G06F 3/0481; G06F 17/30

(52) U.S. Cl. CPC G06F 3/0481; G06F 17/30053; G06F 17/30598

(57) ABSTRACT

A dynamic playlist generator is configured to provide users with a personalized playlist of media tracks based on user data. The system is configured to upload and analyze media tracks, extract enhanced metadata therefrom, and assign classifications to the media tracks based on the enhanced metadata. The system determines one or more conditions of the user and generates a personalized playlist based on matching the user's condition with media tracks that have classifications that correspond to such condition. The classifications can include categories of moods or pacing level of the media tracks. Personalized playlists can be generated based on matching user mood selections with the mood categories of the media tracks, or based on matching user biorhythmic data with the pacing level of the media tracks.

### PRIORITY

The present patent application is a continuation-in-part of U.S. patent application Ser. No. 14/218,958, filed Mar. 18, 2014, entitled “Method and System for Dynamic Intelligent Playlist Generation,” which claims priority to and incorporates by reference herein U.S. Provisional Patent Application No. 61/802,469, filed Mar. 16, 2013, entitled “Music Playlist Generator.”

### FIELD OF THE INVENTION

At least certain embodiments of the invention relate generally to media data, and more particularly to generating a personalized playlist based on media data.

### BACKGROUND OF THE INVENTION

Heretofore consumers have had to manage their personal medial playlists actively, switch between multiple playlists, or scan through songs/tracks manually. As users' media collections grow, this can become increasingly cumbersome and unwieldy. This is because conventional playlists are static and not personalized with preset lists configured by users.

### SUMMARY

Embodiments of the invention described herein include a method and system for generating one or more personalized playlists using a novel playlist generation system. The playlist generation system is configured for matching customized playlists with user mood or activity levels. In one embodiment, the system can accomplish this by (1) uploading and analyzing a plurality of media tracks stored in memory of a user's device or stored at an external database via a network, (2) reading a basic set of metadata stored on the media tracks, (3) extracting an enhanced (or extended) set of metadata from the media tracks (or from portions of the media tracks), and (4) assigning classifications to the media tracks (or portions thereof) based on the enhanced set of metadata. A condition of the user can then be determined and a personalized playlist generated based on matching the condition of the user with assigned classifications of the media tracks that correspond to user conditions. The condition of the user can either be determined manually based on one or more mood selections input by the user or automatically based on biorhythmic information of the user.

In a preferred embodiment, the classifications include categories of moods. Personalized playlists can be generated based on matching mood selections input by the user with mood categories assigned to the media tracks. In another embodiment, the classifications can include the pacing level of the media tracks or a combination of mood categories and pacing level of the media tracks. Personalized playlists can be generated based on matching biorhythmic data from a user with the pacing level of the media tracks.

In yet other embodiments, a system for generating a personal playlist is disclosed. Such a system would typically include a processor, a memory coupled with the processor via one or more interconnections, such as a data and/or control bus, and a network interface for communicating data between the system and one or more networks. The system can upload a plurality of media tracks stored on the user's device, or it can access this information from a database on a network. The system can also be configured to generate and send the personalized playlists to user devices from one or more sources on the network(s).

For a better understanding of at least certain embodiments, reference will be made to the following Detailed Description, which is to be read in conjunction with the accompanying drawings, wherein:

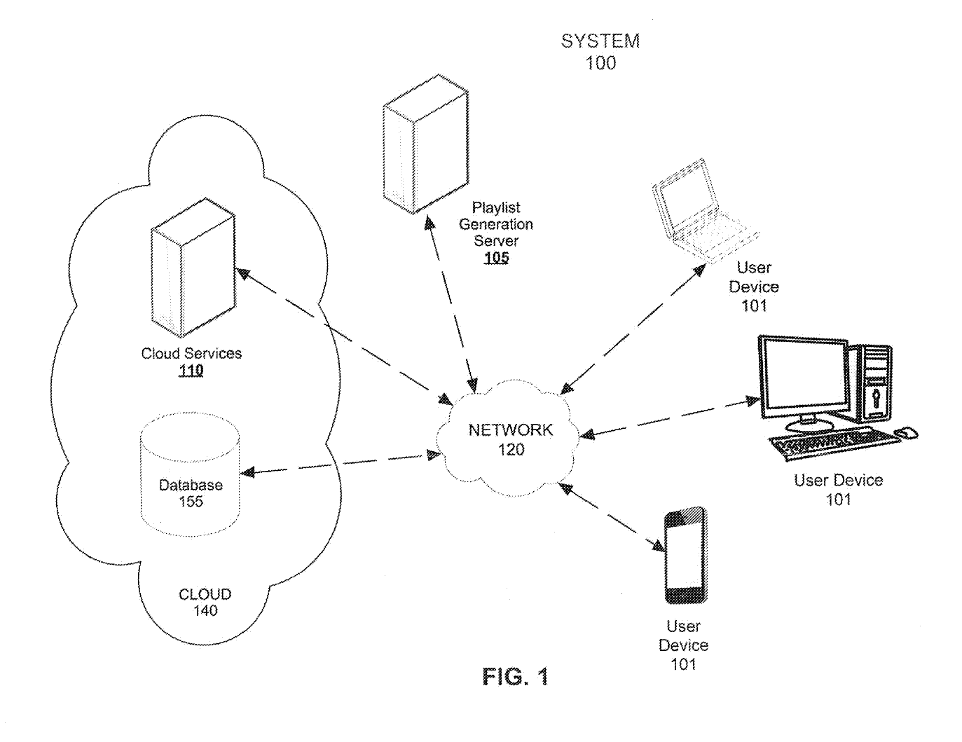

FIG. 1 depicts an example block diagram of an embodiment of a dynamic playlist generation system.

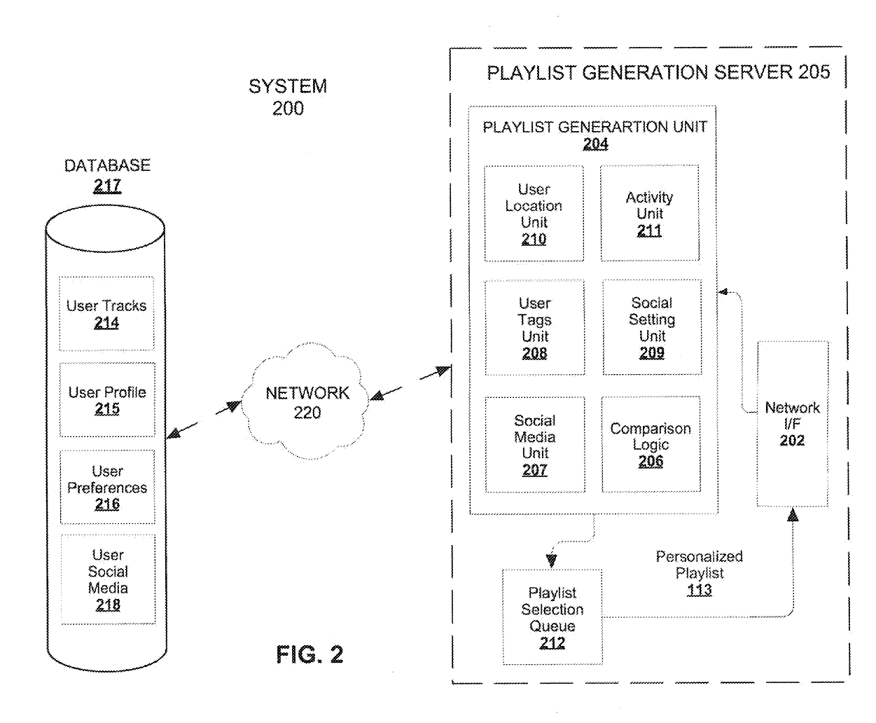

FIG. 2 depicts an example block diagram of an embodiment of a dynamic playlist generation system.

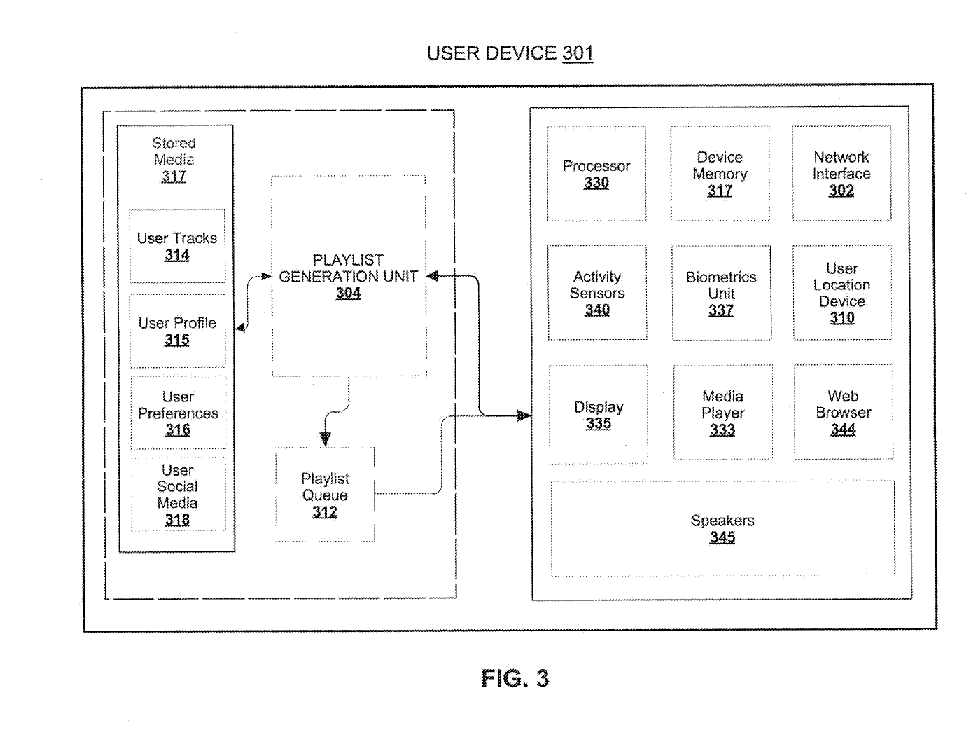

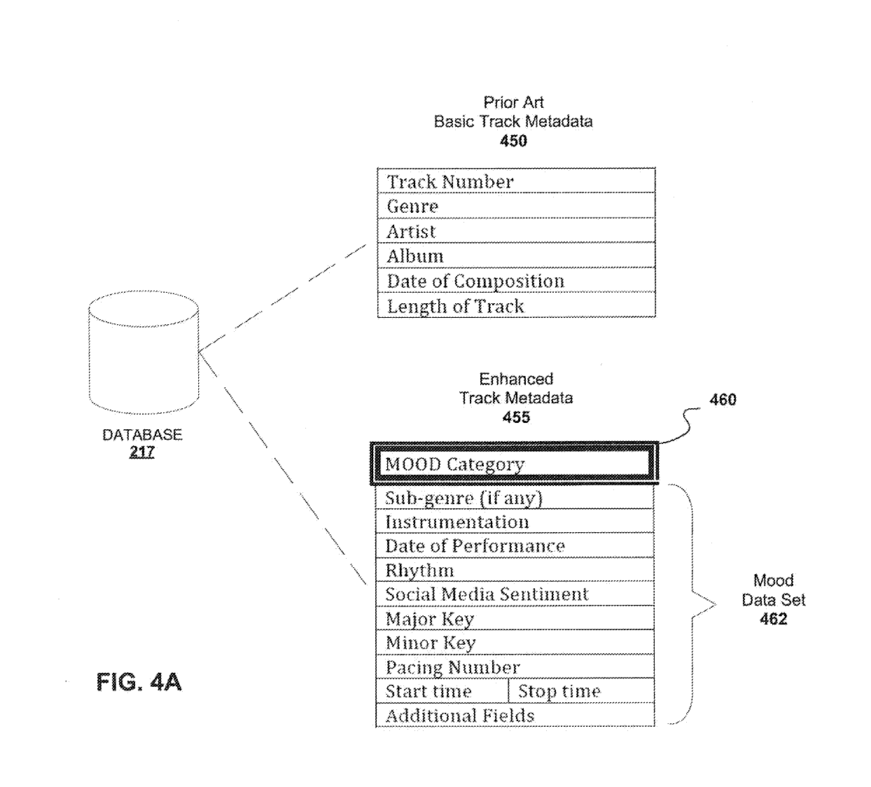

FIG. 3 depicts an example block diagram of an embodiment of a user device for use with a dynamic playlist generation system.

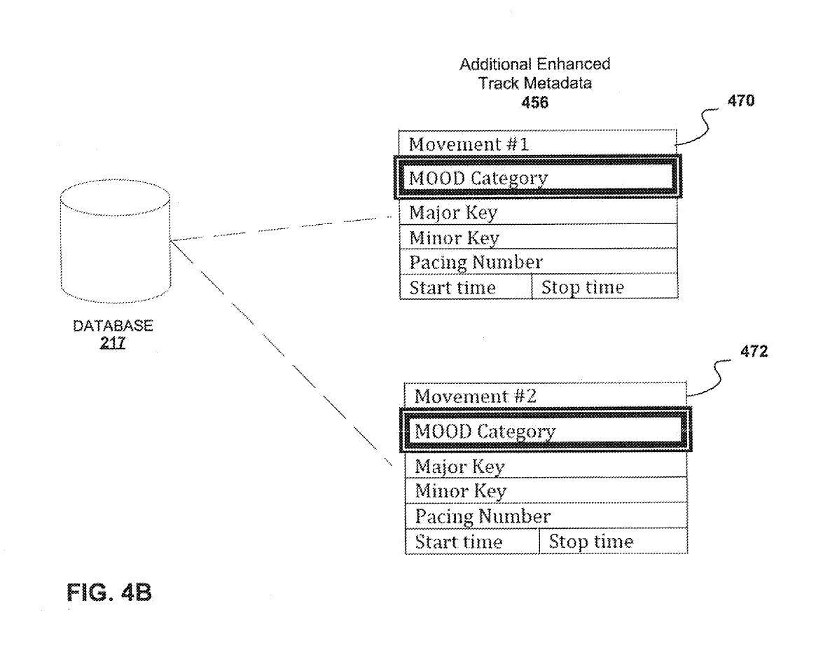

FIG. 4A depicts an example embodiment of metadata extracted from a media track during a dynamic playlist generation process.

FIG. 4B depicts an example embodiment of metadata extracted from a portion of a media track during a dynamic playlist generation process.

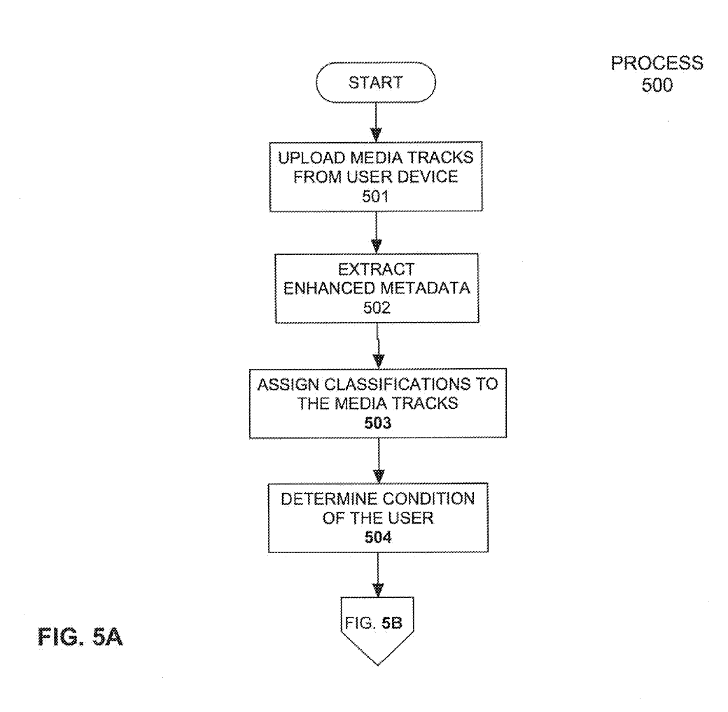

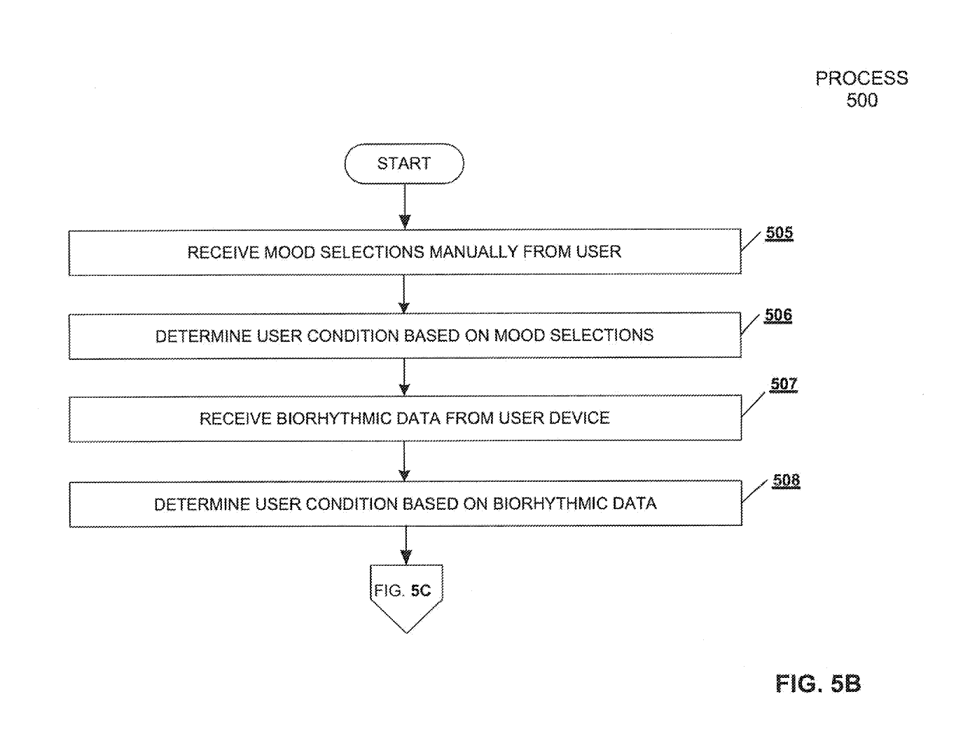

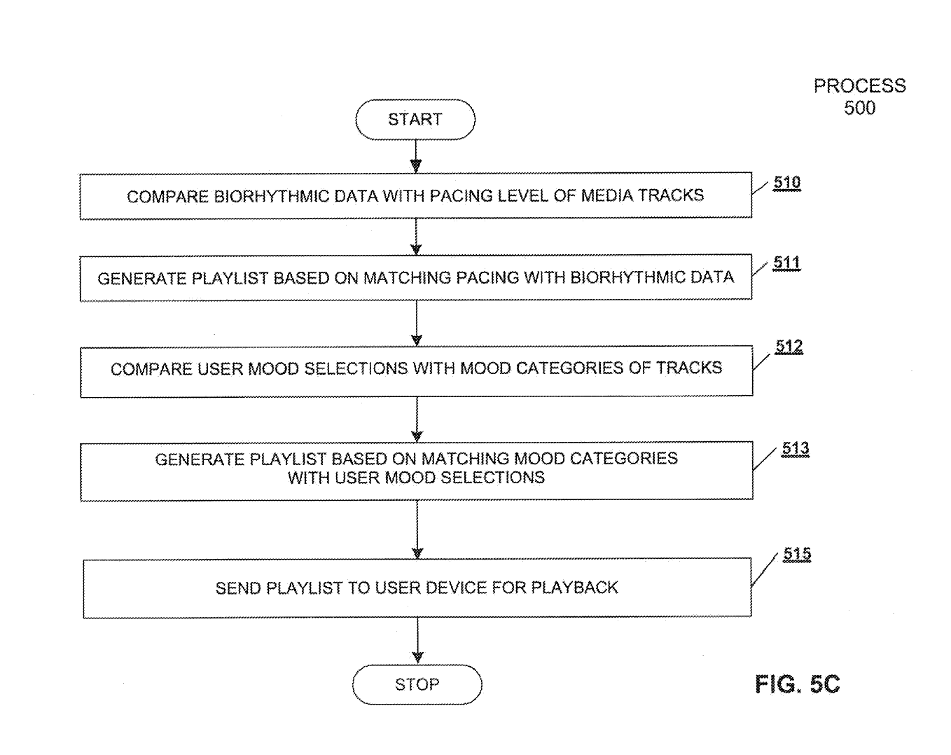

FIG. 5A depicts an example embodiment of a process for dynamically generating a personalized playlist.

FIG. 5B depicts an example embodiment of a process for determining condition of a user for dynamic playlist generation.

FIG. 5C depicts an example embodiment of a process for dynamically generating a personalized playlist.

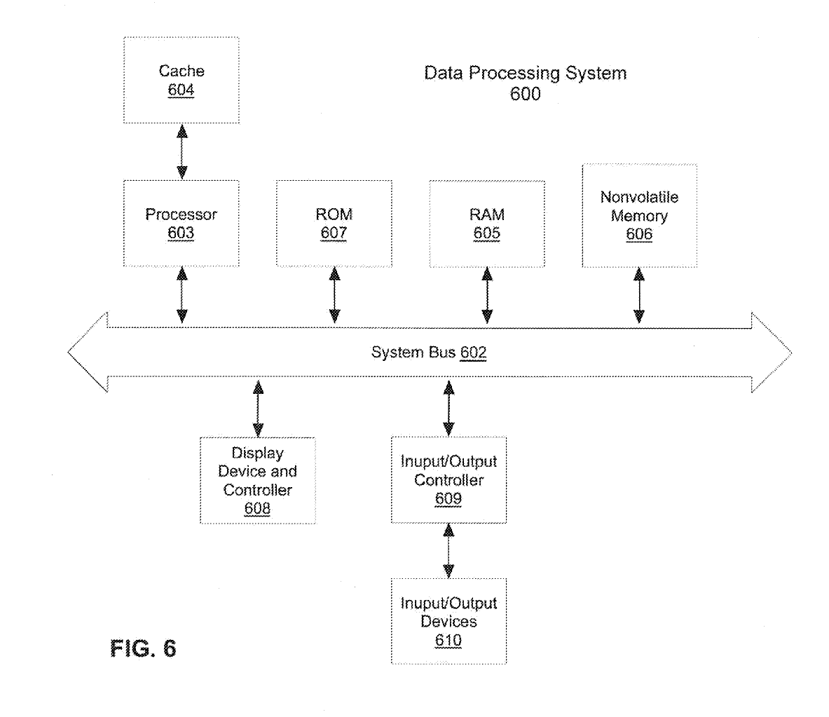

FIG. 6 depicts an example data processing system upon which the embodiments described herein may be implemented.

### DETAILED DESCRIPTION

Throughout the description, for the purposes of explanation, numerous specific details are set forth in order to provide a thorough understanding of the present invention. It will be apparent to one skilled in the art, however, that the present invention may be practiced without some of these specific details. In other instances, well-known structures and devices are shown in block diagram form to avoid obscuring the underlying principles of embodiments of the invention.

The embodiments described herein include a method and system for generating one or more customized playlists on user electronic devices. Such a playlist generation system can sit on a device or in a cloud computing server, dispensing from the cloud and connecting to other cloud services such as Amazon cloud music, etc. The playlists can be generated to match a user's mood or activity level. For example, a user may be on a long road trip and may desire to listen to some upbeat music. The system can receive this input and automatically provide a playlist geared to that user experience. In another example, when a user or group of users is on a mountain biking trip, the system can detect the activity level of the users and can provide personalized playlists to match the user activity. This playlist can further be updated dynamically as the user's activity level changes over time.

The playlist generation system is like an enhanced, targeted, custom shuffle feature. At least certain embodiments are configured to provide an algorithm that generates personalized playlists dynamically to enhance user experience based on determining user mood, location, activity level, and/or social-context. For example, the system does not want to speed you up when the user is trying to relax or slow you down when the user is trying to stay awake. The user's mood can be ascertained based on user input or other user data, and a personalized playlist adapted for that mood can be generated. In such a system, music or other media tracks can be generated and updated dynamically to adapt to a user's mood and other user parameters. Users can provide access or make available their personal media tracks collection to the playlist generation system, and the system can store personal media tracks collection data on disk or in a database in the cloud. The preferred media this system is designed for is music files, but the techniques and algorithms described herein are readily adaptable to any media content including, for example, audio media, electronic books, movies, videos, shorts, etc.

In addition, the personalized playlist can be generated on the user's mobile electronic device itself or it can be generated external to the user's device and communicated to the device via a network or direct connection, such as a Bluetooth or optical network connection; or it can be communicated via both a network connection and a direct connection. For example, the media tracks and assigned classification data and basic and enhanced metadata can be stored on and accessed from a memory on the user's mobile device or via an external database. The external database can be a dedicated database or can be provided by a cloud data storage service provider.

One embodiment for generating a personalized playlist includes uploading and analyzing a plurality of media tracks stored in memory of a user's device or stored at an external database via a network, reading a basic set of metadata stored on the media tracks, extracting an enhanced (or extended) set of metadata from the media tracks (or from portions of the media tracks), and assigning classifications to the media tracks (or portions thereof) based on the basic and enhanced sets of metadata. The condition of the user can then be determined and a personalized playlist can be generated therefrom based on matching the condition of the user with assigned classifications of the media tracks that correspond to user conditions. The condition of the user can either be determined manually based on one or more mood selections input to the user's device or automatically based on biorhythmic information of the user. Users can also select between the manual and automatic modes of operation.

In a preferred embodiment, the classifications include categories of moods. The personalized playlist can be generated based on matching the mood selections of the user with the mood categories assigned to the media tracks. The mood categories can be pre-configured in the system. In addition, a group of moods can be selected and a playlist can be generated based at least in part thereon. The list of mood categories can include, for example, aggressive, angry, anguish, bold, brassy, celebratory, desperate, dreamy, eccentric, euphoric, excited, gloomy, gritty, happy, humorous, inspired, introspective, mysterious, nervous, nostalgic, optimistic, peaceful, pessimistic, provocative, rebellious, restrained, romantic, sad, sexy, shimmering, sophisticated, spiritual, spooky, unpredictable, warm, shadowy, etc.

In another embodiment, the classifications can include a pacing level of the media tracks or a combination of mood category and pacing level of the media tracks. The speed of a media track or portions thereof can be represented as a numeric biorhythmic index representing the media track numerically. The personalized playlist can then be generated based on matching biorhythmic data from a user with the pacing level of the media tracks. The pacing level can be a numeric biorhythmic number index for the media track or portion thereof—it can be another way of representing a media track numerically. A numeric value associated with biorhythmic data received from the user can be matched to the biorhythmic number index for the media tracks and a playlist can be generated therefrom.

The biorhythmic data can be obtained from the user's mobile device or from an electronic device configured to detect user biorhythmic data, or from both. For example, popular today are wearable electronic devices that can be used to detect user biorhythmic data such as pulse, heart rate, user motion, footsteps, pacing, respiration, etc. Alternatively, applications running on the user's mobile device can be used to detect user biorhythmic data, or combination of wearable electronic devices and applications running on the user's mobile device. Many mobile devices these days include several sensors adapted to receive user biorhythmic information.

The system is further configured for receiving user preferences information or user feedback information and generating a personalized playlist based at least in part thereon. The system can also harvest user listening history and use that information for generating the personalized playlists. For instance, the favorite or most frequently played media tracks of a user, or skipped track information can be used in generating playlists. In addition, mood information can also be harvested from one or more social media connections of a user and used to generate playlists. Social media sentiment of the user's connections can also be used. The personalized playlists can also be generated based at least in part on averaging mood information of social media contacts of the user.

The set of basic metadata contains basic categorizations about a media track and is typically stored on and/or associated with media tracks for indexing into the tracks. This basic metadata generally includes some combination of track number, album, artist name, name of track, length of track, genre, date of composition, etc. The set of enhanced or extended metadata, on the other hand, is generally not stored on or associated with the media tracks, but can be added to the basic metadata. The enhanced metadata can be extracted from the media tracks or portions thereof. This enhanced set of metadata can include, for example, date of performance, date of composition, instrumentation, mood category, pacing level, start and stop time of portions of the track (referred to herein as “movements”), etc. This enhanced metadata can be used to generate one or more personalized playlists for users. The enhanced metadata can also be used to associate, for example, a date of performance with a social timeline of user experience.

The playlist generator unit is adapted to determine a condition of the user and to generate a personalized playlist based on the user's condition. The condition of the user is either determined manually based on a mood selection or group of mood selections input by the user, or can be determined automatically based on user biorhythmic information. The system can also include comparator logic configured to match the mood selections of the user with the mood categories assigned to the media tracks. The comparator logic can also be configured to match biorhythmic information of the user with the pacing level assigned to the media tracks as discussed above.

In at least certain embodiments, after configuration and authentication, the user can make one or more mood selections and those selections can be input into the playlist generator unit. In addition, the user may choose to reveal his or her location, presence, social context, or social media context. The system can generate a playlist for one or more media players, which in turn can be configured to play the received media. The techniques described herein are not limited to any particular electronic device or media player associated therewith. Further, the playlists can be of variable length (as desired or selected by users) and can take into consideration one or more of the following: (1) user mood; (2) user location (contextual e.g. in a car, or physical e.g. “5th and Jackson Ave in San Jose, Calif. USA”); (3) user presence (what condition the user is in from other devices stand-point, e.g. in a conference call); or (4) user social context or social media context (what the user's social media connections are doing).

The media tracks can also be broken down into portions or “movements.” This can be done in circumstances where a different mood or pacing level is assigned to different sections or “movements” of the media track. There could be one speed (pacing) throughout a single media track or it could change throughout the track. It could be divided up into multiple movements within a track with multiple corresponding start and stop times, each movement represented by a pacing number. In such cases, the personalized playlists may include media tracks, movements, or both media tracks and movements intermixed and assigned to a particular playlist based on mood category and/or pacing level.

The system can also have an advanced mode whereby users can choose to create an algorithm where music is selected based on any a predetermined musical criteria similar to what a human disc jockey might choose at an actual event. In addition, the system can customize the generated playlists. For example, tempo, vitality, or era corresponding to a user's age or cultural background can be used to enhance the playlist for a specific occasion or location of listeners. Online advertisements can also be targeted based on the mood of the user ascertained by the system.

FIG. 1 depicts an example block diagram of an embodiment of a dynamic playlist generation system with an external playlist generator 105. In the illustrated embodiment, system 100 includes an external playlist generation server 105 in communication with one or more user devices 101 via one or more networks 120. Playlist generation server 105 can be any network computer server as known in the art. Playlist generation server 105 can perform the techniques described herein by itself or in combination with one or more cloud services 110. The playlist generation server 105 can further be a standalone server or can be an array of connected servers working in combination to generate personalized playlists according to the techniques described herein. Playlist generation server 105 can access a database 155 for storage and retrieval of user tracks, classifications of the tracks, and/or basic or enhanced metadata associated with the media tracks. Database 155 can also be adapted to store user profile information, user preferences, user listening history, as well as the social media connections of users.

FIG. 2 depicts an example block diagram of a more detailed embodiment of a dynamic playlist generation system. System 200 includes a playlist generation server 205 in communication with one or more databases 217 via one or more networks 220. In one embodiment, the playlist generation server 205 performs the techniques described herein by interacting with an application stored on user devices (see FIG. 1). In another embodiment, the playlist generation server 205 can be a web server and can interact with the user devices via a website. Playlist generation server 205 may present users with a list of all mood keywords that are available so the user can pick the ones that are of interest. Users can also select groups of moods. Playlist generation server 205 communicates with the user devices and database 217 via one or more network interfaces 202. Any network interface may be used as understood by persons of ordinary skill in the art.

In the illustrated embodiment, playlist generation server 205 includes a playlist generation unit 204 containing on or more algorithms to generate customized playlists that are based on user data and personalized media preferences. Playlist generation unit 204 can be configured to receive user media tracks and other user information from the user devices and to provide personalized playlists to the user devices via the network(s) 220 using the network interface 202. The playlist generation unit 204 includes, and receives inputs from, one or more of the following units: (1) a user location unit 210, (2) a social setting unit 209, (3) an activity unit 211, (4) a user tags unit 208, and (5) a social media unit 207. The playlist generation unit 204 provides outputs, based on one or more algorithms, to a playlist selection queue 212 for outputting the personalized playlists to the user devices. Outputs from the playlist generation unit 204 can include a targeted playlist for use on the user's device(s), an aggregation of songs from the user's current device, and any recommendations from social media connections of the user. Further queue 212 can be tuned to social setting, location, and activity of the user. The user can select (or not) media tracks such as types of music, e.g., classical, popular, jazz; and can select depending on one or more tuning categories.

The playlist selection queue 212 can then output a targeted playlist to the users' devices according to all the aforementioned inputs from units and database 217. This playlist can be temporal, including user favorites and weights of each output, time of play, as well as the additional ability to ramp up or down depending on settings configured by the user. Stored media from the user's device can then be provided to the database 217. In one embodiment, the stored media includes music songs and properties data. User device thereafter stores the playlist on a memory of the user device, which can then be fed back into a database 217. System 200 enables user device to access the stored media and to play the targeted playlist. Playlist generation unit 204 also includes comparison logic 206 for comparing values of the mood selections by users with the mood categories assigned to the user's media tracks. Comparison logic 206 can also be configured to compare values of user biorhythmic data with the pacing level assigned to the user's media tracks or portions thereof.

The system can further include a user location unit 210 adapted to determine the user's location based on location information received from the user's device. For example, a Global Positioning System (“GPS”) device located on the user's mobile device can be used to determine the user's geographic location, and this information can be further used by the system to assist in generating one or more personalized playlists of media tracks for the user. Such location information can include, for example, driving (short trip or long trip), walking, at home, in the office, on public transit, at breakfast, etc.

In the illustrated embodiment, the playlist generation unit 204 can includes an activity unit 211 configured to ascertain the activities or activity level users are engaged in based on user biorhythmic information. Activity unit 211 can include the user's current activity in the location of the user including, for example, walking, driving, jogging, etc. This information can be provided by inputs to the user's device such as motion detectors, GPS devices, etc. If the user's heart rate is very high, the system may determine the user is engaged in physical exercise. This information can be combined with other information and used when generating personalized playlists. User historical data can also be combined with the biorhythmic data to provide enhanced information regarding the user's biorhythmic data and activity level.

The playlist generation unit 204 can also include a user tags unit 208 to receive user tags and use them to generate playlists in combination with other factors. Users tags include user feedback to the system over time such as which media tracks the user has selected as well as current user favorites. The system is dynamic so it allows for new user tagging. Users can add or remove media tracks from a playlist, give a certain media track a “thumbs up,” etc.

A social media unit 207 can also be included in the playlist generation unit 204 to harvest information relating to the user's social media connections and can use that information when it generates customized playlists. Social media unit 207 can include social media content from various sources such as Google +, Facebook, LinkedIn, public cloud playlists, etc. Social sentiment can be harvested such as in the form of hash tag words from a user's social media feed, such as “#Thisiscool,” etc. This information can be used to enhance the personalized playlists generated by the system. The system takes into consideration a user's social graph, and harvests mood information from those connections at each point in time. A selection tab can be provided to select the user's mood selections alone or a combination of the user's mood selections and the mood selections of groups of social media connections in the user's social graph. In such cases, a group playlist can be generated. Groups are customizable within a social network. A social setting unit 209 can also be included in the playlist generation unit 204 and used to make determinations as to the user's social setting based on user information provided by the user devices. A users social setting can include, for example, working, taking a coffee break, alone, with friends, at a wedding, etc. This information can also be used in combination with other information to generate the personalized playlists.

In the illustrated embodiment, the playlist generation unit 204 in the playlist generation server 205 is in communication with a database 217. Database 217 can be a meta-content database adapted to store the user's media tracks 214 and additional user data such as user profile information 215, user preferences 216, and user social media data 218. Database 217 can include content the user has interacted with, both on and off the system 200, as well as content the user's friends have interacted with. In one embodiment, database 217 is an external database as shown. In alternative embodiments to be discussed infra, the playlist generation unit 204 can be located on the user device and the user tracks 214 and other user information can be stored in a memory of the user devices. In such a case, the memory on the user device performs the same functionally as database 217, but does so internally to the user device without connecting to a network. Regardless of where located, the data stored includes the user's media tracks 214 along with the basic and enhanced metadata and the classifications information of the media tracks. The database 217 therefore contains the enhanced information about each of the user's media tracks.

Database 217 (or user device memory) can also store user profile information 215 such as, for example, user name, IP address, device ID, telephone number, email address, geographic location, etc. User profile information 215 can include authentication and personal configuration information. User preferences information 216 and user social media 218 can also be stored in database 217. User preferences information 216 can include, for example, user listening history, skipped track history, user tags, and other user feedback about media tracks, etc. User preferences data can be located anywhere, on a smartphone or in database, and can be harvested. User preferences data could also reside on the user's smartphone and then moved to the cloud or other network, for example, and a song could be repeated because the user indicated he or she liked it. When user preferences are received, they can be moved up into the cloud and aggregated and modified over time. User social media information 218 can include, for example, a user's social media connections, social media sentiment, etc.

System 200 can be comprised of several components including the components depicted in FIG. 2 above. System 200 can further include the following optional components: (1) a contextual parameter aggregator unit configured to collect and aggregate user data; (2) a data analytics unit to determine the efficacy of the media track data to improve the playlist generation algorithm over time; or (3) a music database interface including a web interface to allow users to manually input information to improve media track data.

FIG. 3 depicts an example block diagram of an embodiment of a user device for use with a playlist generation system that performs the techniques described herein. In the illustrated embodiment, user device 301 includes customary components of a typical smartphone or equivalent mobile device including a processor 330, device memory 317, one or more network interfaces, a user location device 310 such as a GPS device, a media player 333, a web browser 344, a display 335, and speakers 345. Such components are well known in the art and no further detail is provided herein.

User device 301 can further include activity sensors 340 and a biometrics unit 337. User device 301 may include, for example, motion sensors, orientation sensors, temperature sensors, light sensors, user heart beat sensors, user pulse sensors, respiration sensors, etc. This output data can be used to determine the activity or activity level a user is engaged in. Alternatively, a user may possess one or more wearable electronic devices configured to collect and transmit user biorhythmic and activity information to the user device 301 via a network or direct connection such as a Bluetooth connection. Biometrics unit 337 is configured to collect this user biorhythmic and activity information output from one or more activity sensors 340 and to provide this information to the playlist generation unit 304. The biometrics unit 337 can be a dedicated unit configured in computer hardware or combination of hardware and software. Alternatively, the biometric unit 337 can be an application running on the user device 301 and integrated with one or more electronic devices configured to detect user activity levels.

In one embodiment, the playlist generation unit is external to the user device 301 and can be accessed via one or more networks as described above with respect to FIG. 2. In the illustrated embodiment of FIG. 3, the playlist generation unit 304 is located on the user device 301. The playlist generation unit 304 can be a dedicated hardware unit or combination of hardware and software; or it can be a software platform stored in device memory 317 of the user device 301. As shown, playlist generation unit 304 is coupled with an output playlist queue 312 for providing personalized playlists that can be displayed using a media player 333 and output to a display 335, speakers 345, or other output device of the user device 301. Playlist generation unit 304 is further coupled with the user information 314 through 318 as before, but in this case, the user information 314-318 is located in one or more of the device memories 317 of the user device 301. Any combination of user information 314-318 can be stored on the memory 317 of the user device or on an external database 217 accessible via one or more networks.

FIG. 4A depicts an example embodiment of metadata extracted from a media track during a dynamic playlist generation process. In the illustrated embodiment, database 217 (or equivalently memory 317 of FIG. 3) stores both the basic media track metadata 450 and the enhanced media track metadata 455. The basic metadata is typically stored with the media tracks. In one embodiment, the enhanced metadata is extracted from the media tracks and can be added to the basic metadata of the tracks. In this way, the enhanced metadata is extended metadata. In other embodiments, the enhanced metadata can be stored with the corresponding media tracks and need not be explicitly added to the basic metadata.

The basic track metadata 450 can include track number, track length, artist, song name, album, date of composition, genre, etc. The enhanced track metadata 450 is extracted from the media tracks and from the basic metadata and includes one or more mood categories 460 and a mood data set 462. The mood data set 462 can include pacing number, sub-genre, instrumentation, date of performance, rhythm, major key, minor key, social media sentiment, as well as start and stop times for any movements. In one embodiment, the mood categories are determined based on an algorithm with the mood data set 462 as its inputs. The system is expandable to allow additional fields to be added over time as well. These additional fields may be generated based on historical user information ascertained over time. Further, the additional metadata fields can be of variable length so new information can be added from ingesting social media content or other user feedback or preferences. This basic and enhanced metadata can be used by the dynamic playlist generation system when generating one or more personalized playlists for users.

FIG. 4B depicts an example embodiment of metadata extracted from a portion of a media track during a dynamic playlist generation process. As described above, media tracks can be further subdivided into movements to account for changing mood categories and pacing level within a single media track. In such a case, a plurality of movements can be defined within the media track. Each movement will be associated with a mood category and pacing level in the same way an entire media track is classified according to the discussion above. Any number of movements may be defined within a media track. In the illustrated embodiment, database 217 or memory 317 includes additional enhanced track metadata 456 that is be broken down into movement#1 470 and movement#2 472. This information includes the same (or more or less) information as contained in the enhanced metadata 455 of FIG. 4A. This additional enhanced metadata can be used by the dynamic playlist generation system when generating one or more personalized playlists for users. In this case, though, the playlist may include one or more movements of tracks or may contain movements of tracks intermixed with complete tracks and categorized according to mood selection or user biorhythmic data.

FIG. 5A depicts an example embodiment of a process for dynamically generating a personalized playlist. Process 500 begins at operation 501 where media tracks are first uploaded from the users device. The media tracks are then analyzed and enhanced metadata is extracted therefrom (operation 502). At operation 503, one or more classifications are assigned to the media tracks. As described previously, embodiments include classifying the media tracks into mood categories or a numeric index representing pacing level of the media tracks. The user's condition is then determined at operation 504.

The user's condition can be manually input by the user as a mood selection or group of mood selections, or it can be determined dynamically based on biorhythmic data of the user. Control of process 500 continues on FIG. 5B. At operation 505, mood selections are received manually from the user and are used to determine the user's condition (operation 506). At operation 507, biorhythmic data of the user is received from one or more of the user's electronic devices and is used to determine the user's condition (operation 508).

Control of process 500 continues on FIG. 5C. One or more personalized playlists are generated based on the user's condition ascertained by the system. At operation 510, the user's biorhythmic data is compared with the pacing level of the media tracks and a playlist is generated based on matching the biorhythmic data with the pacing level (operation 511). At operation 512, the user's mood selections are compared to the mood categories associated with the media tracks and a playlist is generated based on matching the mood categories with the user mood selections (operation 513). The playlist can then be sent to the user's device or to a media player within the user's device for playback (operation 515). This completes process 500 according to one example embodiment.

There are many uses such a playlist generation system can be used for. In one case, it can be used as a dedicated device like a jukebox with a localized interface. The device can poll localized information such as user favorites and biorhythmic data and do a round-robin average of that data across everyone in the locality. The device could then generate a playlist based on that localized information just like a jukebox. Such a jukebox could have its own playlist or can generate a playlist based on harvesting user favorites data from the locality.

FIG. 6 depicts an example data processing system upon which the embodiments described herein may be implemented. As shown in FIG. 6, the data processing system 601 includes a system bus 602, which is coupled to a processor 603, a Read-Only Memory (“ROM”) 607, a Random Access Memory (“RAM”) 605, as well as other nonvolatile memory 606, e.g., a hard drive. In the illustrated embodiment, processor 603 is coupled to a cache memory 604. System bus 602 can be adapted to interconnect these various components together and also interconnect components 603, 607, 605, and 606 to a display controller and display device 608, and to peripheral devices such as input/output (“I/O”) devices 610. Types of I/O devices can include keyboards, modems, network interfaces, printers, scanners, video cameras, or other devices well known in the art. Typically, I/O devices 610 are coupled to the system bus 602 through I/O controllers 609. In one embodiment the I/O controller 609 includes a Universal Serial Bus (“USB”) adapter for controlling USB peripherals or other type of bus adapter.

RAM 605 can be implemented as dynamic RAM (“DRAM”), which requires power continually in order to refresh or maintain the data in the memory. The other nonvolatile memory 606 can be a magnetic hard drive, magnetic optical drive, optical drive, DVD RAM, or other type of memory system that maintains data after power is removed from the system. While FIG. 6 shows that nonvolatile memory 606 as a local device coupled with the rest of the components in the data processing system, it will be appreciated by skilled artisans that the described techniques may use a nonvolatile memory remote from the system, such as a network storage device coupled with the data processing system through a network interface such as a modem or Ethernet interface (not shown).

With these embodiments in mind, it will be apparent from this description that aspects of the described techniques may be embodied, at least in part, in software, hardware, firmware, or any combination thereof. It should also be understood that embodiments could employ various computer-implemented functions involving data stored in a computer system. The techniques may be carried out in a computer system or other data processing system in response executing sequences of instructions stored in memory. In various embodiments, hardwired circuitry may be used independently or in combination with software instructions to implement these techniques. For instance, the described functionality may be performed by specific hardware components containing hardwired logic for performing operations, or by any combination of custom hardware components and programmed computer components. The techniques described herein are not limited to any specific combination of hardware circuitry and software.

Embodiments herein may also be implemented in computer-readable instructions stored on an article of manufacture referred to as a computer-readable medium, which is adapted to store data that can thereafter be read and processed by a computer. Computer-readable media is adapted to store these computer instructions, which when executed by a computer or other data processing system such as data processing system 600, are adapted to cause the system to perform operations according to the techniques described herein. Computer-readable media can include any mechanism that stores information in a form accessible by a data processing device such as a computer, network device, tablet, smartphone, or any device having similar functionality.

Examples of computer-readable media include any type of tangible article of manufacture capable of storing information thereon including floppy disks, hard drive disks (“HDDs”), solid-state devices (“SSDs”) or other flash memory, optical disks, digital video disks (“DVDs”), CD-ROMs, magnetic-optical disks, ROMs, RAMs, erasable programmable read only memory (“EPROMs”), electrically erasable programmable read only memory (“EEPROMs”), magnetic or optical cards, or any other type of media suitable for storing instructions in an electronic format. Computer-readable media can also be distributed over a network-coupled computer system stored and executed in a distributed fashion.

It should be understood that the various data processing devices and systems are provided for illustrative purposes only, and are not intended to represent any particular architecture or manner of interconnecting components, as such details are not germane to the techniques described herein. It will be appreciated that network computers and other data processing systems, which have fewer components or perhaps more components, may also be used. For instance, these embodiments may be practiced with a wide range of computer system configurations including any device that can interact with the Internet via a web browser or an application such as hand-held devices, microprocessor systems, workstations, personal computers (“PCs”), Macintosh computers, programmable consumer electronics, minicomputers, mainframe computers, or any mobile communications device including an iPhone, iPad, Android, or Blackberry device, or any device having similar functionality. These embodiments can also be practiced in distributed computing environments where tasks are performed by remote processing devices that are linked through a wire-based or wireless network.

Throughout the foregoing description, for the purposes of explanation, numerous specific details were set forth in order to provide a thorough understanding of the invention. It will be apparent, however, to persons skilled in the art that these embodiments may be practiced without some of these specific details. Accordingly, the scope and spirit of the invention should be judged in terms of the claims that follow as well as the legal equivalents thereof.

What is claimed is:

1. A method of generating a playlist comprising:
uploading a plurality of listed media tracks stored in memory of a user's device;
analyzing the plurality of listed media tracks;
reading a first set of metadata stored on the media tracks;
extracting a second set of enhanced metadata from the media tracks or portions thereof;
assigning one or more classifications to the media tracks or portions thereof based on values of the set of enhanced metadata, wherein the classifications include mood categories and pacing level of the media tracks;
determining a condition of the user, wherein the condition of the user is either determined manually based on one or more mood selections input by the user or automatically based on user biorhythmic information in the set of enhanced metadata, and wherein the user can select between a manual or automatic mode of operation;
generating a personalized playlist based on the user's determined condition; and
sending the personalized playlist to the user's device.

2. The method of claim 1 wherein the personalized playlist is generated based on matching the mood selections of the user with the mood categories assigned to the media tracks.

3. The method of claim 1 wherein the personalized playlist is generated based on matching the user biorhythmic information in the set of enhanced metadata with the pacing level assigned to the media tracks.

4. The method of claim 1 further comprising storing the media tracks along with the one or more classification and the set of enhanced metadata in a database.

5. The method of claim 1 further comprising targeting online advertisements based on the user's mood selection.

6. The method of claim 1 further comprising receiving user preferences information and generating the personalized playlist based at least in part thereon.

7. The method of claim 1 further comprising receiving feedback information from user tags and generating the personalized playlist based at least in part thereon.

8. The method of claim 1 further comprising harvesting user listening history information and generating the personalized playlist based at least in part thereon.

9. The method of claim 8 wherein the user listening information includes favorite tracks of the user and skipped track information.

10. The method of claim 1 further comprising harvesting mood information from social media contacts of the user and generating the personalized playlist based at least in part thereon.

11. The method of claim 1 further comprising determining social media sentiment associated with a track and generating the personalized playlist based at least in part thereon.

12. The method of claim 1 wherein the set of enhanced metadata includes date of performance and data of composition of a track.

13. The method of claim 12 further comprising associating date of performance with a timeline of user experience and generating the personalized playlist based at least in part thereon.

14. The method of claim 1 further comprising receiving a selection of a group of moods from the user and generating the playlist based at least in part thereon.

15. The method of claim 1 wherein the enhanced metadata includes instrumentation used in a track.

16. A system comprising:
a processor;
a memory coupled with the processor via an interconnect bus;
a network element in communication with the processor and adapted to:
upload a plurality of media tracks stored in a user's device; and
send a personalized playlist to the user's device;
a playlist generator configured to:
analyze the plurality of media tracks;
read a first set of metadata stored on the media tracks;
extract a second set of enhanced metadata from the media tracks or portions thereof;
assign one or more classifications to the media tracks or portions thereof based on values of the set of enhanced metadata, wherein the classifications include mood categories and pacing level of the media tracks;
determine a condition of the user, wherein the condition of the user is either determined manually based on one or more mood selections input by the user or automatically based on user biorhythmic information in the set of enhanced metadata, and wherein the user can select between a manual or automatic mode of operation; and
generate a personalized playlist based on the user's determined condition.

17. The system of claim 16 further comprising a comparator configured to match the mood selections of the user with the mood categories assigned to the media tracks.

18. The system of claim 16 further comprising a comparator configured to match the user biorhythmic information in the set of enhanced metadata with the pacing level assigned to the media tracks.

19. The system of claim 16 further comprising a database for storing the media tracks along with the classifications and the set of enhanced metadata in a database.

20. The system of claim 16 further comprising a user activity unit adapted to determine user activity based on user biorhythmic and delta positional information received from the user's device.

21. The system of claim 16 further comprising a user location unit adapted to determine user location based on location information received from the user's device.

22. The system of claim 16 wherein the set of enhanced metadata includes a number representing pacing of the media track or portions thereof.

23. The system of claim 16 further comprising a user tags unit adapted to receive user tags, wherein the playlist generator is further adapted to generate the personalized playlist based at least in part on user tags information.

24. The system of claim 16 wherein the playlist generator is further adapted to generate the personalized playlist based at least in part on user listening history.

25. The system of claim 16 further comprising a social media unit adapted to harvest social sentiment associated with a track from social media contacts of the user.

26. The system of claim 16 wherein the playlist generator is further adapted to generate the personalized playlist based at least in part on averaging mood information of social media contacts of the user.
